(19) United States
(12) Patent Application Publication
(10) Pub. No.: US 2013/0066981 A1
(43) Pub. Date: Mar. 14, 2013

(54) METHOD OF PROVIDING TOPIC-BASED SOCIAL NETWORK SERVICE

(71) Applicants: Kyu-In PARK, Seoul (KR); Jong-Tae PARK, Daegu (KR)

(72) Inventors: Kyu-In PARK, Seoul (KR); Jong-Tae PARK, Daegu (KR)

(73) Assignee: KYUNGPOOK NATIONAL UNIVERSITY INDUSTRY-ACADEMIC COOPERATION FOUNDATION, Daegu (KR)

(21) Appl. No.: 13/330,180

(22) Filed: Dec. 19, 2011

(30) Foreign Application Priority Data
Sep. 9, 2011 (KR) 10-2011-0092129

(51) Int. Cl. G06F 15/16

(52) U.S. Cl. 709/206

(57) ABSTRACT

Provided are method of providing topic-based social network service. Present invention provides a method of providing a topic-based social network service (SNS), in which from among comment content written about a specific topic entity, comment content uploaded by users having a personal relationship (such as a friend or acquaintance relationship) with a logged-in user or by users designated as experts on the specific topic entity is provided to the logged-in user so that the logged-in user can secure reliable information about the specific topic entity.

### CROSS-REFERENCE TO RELATED APPLICATION

This application claims priority from Korean Patent Application No. 10-2011-0092129 filed on Sep. 9, 2011 in the Korean Intellectual Property Office, the disclosure of which is incorporated herein by reference in its entirety.

### BACKGROUND OF THE INVENTION

1. Field of the Invention

The present invention relates to a method of providing a topic-based social network service (SNS), and more particularly, to a method of providing a topic-based SNS, in which a specific topic is managed as a topic entity which is a member of the topic-based SNS, and comments made on the topic entity by users, who are other members of the topic-based SNS, are registered to support an exchange of information about the topic entity.

2. Description of the Related Art

Conventional web information search systems have problems providing information specific to a particular situation in real time in a reliable manner. For example, Google™ of U.S and Naver™ of Korea, which are information search systems most widely used around the world, enable users to find necessary information on the Internet by providing most searched information or using other methods based on information stored on the web. However, these information search systems cannot be used to share, in real time, information specific to a particular situation—such as information about today's lunch special in a local restaurant or an accident occurred during a company climbing competition—with related local acquaintances or company colleagues in a reliable manner.

Recently, various social network services (SNSs) based on social relations among people have been introduced. Most SNSs are used to share information based on social relations among people, such as family, school alumni, company colleagues, church members, and members of various communities.

SNS-based information sharing overcomes the above limitations of web search and allows information specific to a particular situation to be shared among friends in a reliable manner. However, most of the conventional SNSs allow information to be shared among friends only. This may increase the reliability of shared information but limit the scope of information sharing only to friends.

In summary, web information search and SNS-based information sharing methods and systems have many problems allowing information specific to a particular situation to be shared among socially related people effectively, widely, and reliably.

As a related art, Korean Patent Publication No. 2011-0002063 discloses a method of accessing reliable user-created content. In this related art, social relations are collected from a plurality of social network sites, and the collected social relations are combined to create user extended social networks for each user. That is, the related art requires collecting information from a plurality of social network sites. This may make it possible to collect reliable content but may not be desirable for extending a personal relationship in one social network site. In addition, collecting information from a plurality of social network sites incurs additional costs.

Conventional SNSs allow not only users but also specific topics (such as region, hobby, content, and company) to function as members thereof. Thus, topic entities can be created for the topics, and comments on the topic entities can be registered. For example, when a topic entity is created for a certain music band, users interested in the band may enter the topic entity of the band and freely leave comments. Thus, information about the band can be shared. In this case, however, it is difficult to trust the content of the comments. This is because the users are not obligated to provide only true information when uploading their comments and because they have no personal relationships with readers of their comments, that is, because the anonymity of comment writers is guaranteed. Consequently, the reliability of the content of the comments cannot be guaranteed.

### SUMMARY OF THE INVENTION

Aspects of the present invention provide a method of providing a topic-based social network service (SNS), in which from among comment content written about a specific topic entity, comment content uploaded by users having a personal relationship (such as a friend or acquaintance relationship) with a logged-in user or by users designated as experts on the specific topic entity is provided to the logged-in user so that the logged-in user can secure reliable information about the specific topic entity.

Aspects of the present invention also provide a method of providing a topic-based SNS, in which from among comment content written about a specific topic entity, comment content uploaded by users having a personal relationship (such as a friend or acquaintance relationship) with a logged-in user is provided to the logged-in user in the form of newsfeeds so that the logged-in user can secure reliable information about the specific topic entity in the form of the newsfeeds.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a method of providing a topic-based SNS. The method includes: receiving comment content about a topic entity in an SNS and storing the received comment content by using an SNS server which provides the SNS; receiving a comment content request signal about a specific topic entity from a user who logged in the SNS, by using the SNS server; and providing, in response to the comment content request signal, comment content written by users who have a friend relationship or an acquaintance relationship with the logged-in user in the SNS from among comment content written about the specific topic entity, by using the SNS server. Here, one or more users of the SNS may connect two SNS users who have the acquaintance relationship, through friend relationships in the SNS.

In order to prevent the number of acquaintances of the logged-in user from increasing unlimitedly, the number of SNS users connecting the two SNS users, who have the acquaintance relationship, through the friend relationships may be limited to a predetermined number or less.

The method may further include selecting an expert on the specific topic entity from SNS service users by using the SNS server, and the providing of the comment content may include further providing comment content written by the expert from among the comment content written about the specific topic entity. That is, the SNS server may provide comment content written not only by SNS users who have a friend relationship or an acquaintance relationship with the logged-in user but also by SNS users designated as experts on the specific topic entity.

The providing of the comment content may include providing information about a social connection path between the logged-in user and a comment content writer in each piece of comment content or providing at least one of a direct message, a chat request, a short message service (SMS) message, an e-mail, and a phone call to a comment content writer as a contact medium in each piece of comment content. Therefore, a medium by which the logged-in user can easily identify his or her relationship with a comment content writer or easily contact the comment content writer may be provided.

According to another aspect of the present invention, there is provided a method of providing a topic-based SNS. The method includes: receiving comment content about a topic entity in an SNS and storing the received comment content by using an SNS server which provides the SNS; and providing a user who logged in the SNS with comment content about each topic entity, which is uploaded to the SNS by users having a friend relationship or an acquaintance relationship with the logged-in user in the SNS, in the form of newsfeeds by using the SNS server. Here, one or more users of the SNS may connect two SNS users, who have an acquaintance relationship, through friend relationships.

The method may further include selecting a topic entity of interest of the logged-in user by using the SNS server, and the providing the logged-in user with the comment content about each topic entity in the form of the newsfeeds may include providing the user who logged in the SNS with comment content about the topic entity of interest, which is uploaded to the SNS by users having a friend relationship or an acquaintance relationship with the logged-in user or by experts on the topic entity of interest, in the form of newsfeeds.

The method may further include selecting an expert on a specific topic entity from SNS service users by using the SNS server, and the providing of the comment content may include further providing comment content written by the expert from among comment content written about the specific topic entity.

### BRIEF DESCRIPTION OF THE DRAWINGS

The above and other aspects and features of the present invention will become more apparent by describing in detail exemplary embodiments thereof with reference to the attached drawings, in which:

FIG. 1 is a conceptual diagram illustrating relationships between users in a topic-based social network service (SNS) according to the present invention;

FIG. 2 shows a topic entity user interface (UI) provided in the topic-based SNS according to an embodiment of the present invention

FIG. 3 shows a topic search UI provided in the topic-based SNS according to an embodiment of the present invention;

FIG. 4 shows an environment setting UI provided in the topic-based SNS according to an embodiment of the present invention; and

FIG. 5 shows a newsfeed UI provided in the topic-based SNS according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

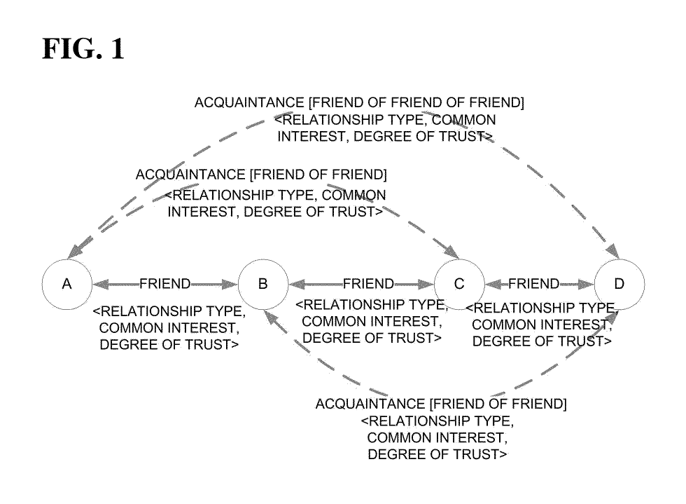

First of all, with reference to FIG. 1, relationships between users in a topic-based social network service (SNS) according to the present invention will be described, and terms used in the present specification will be defined.

In FIG. 1, relationships between four users A through D are illustrated. A ‘friend’ relationship indicated by a solid arrow is a relationship established by consent of users. The friend relationship may be established by mutual consent of both users. The friend relationship may also be established when a user accepts another user's friend request.

An ‘acquaintance’ relationship indicated by a dotted arrow is a relationship established by the extension of the friend relationship. Unlike the friend relationship, the acquaintance relationship is a relationship that can be established by the existence of the friend relationship, without requiring consent of users. Terms used in the present specification will be defined below.

Definition 1: In the present invention, a friend is indicated by F, and those having the friend relationship with the friend, that is, friends of the friend are indicated using an operator oF.

For example, a user's friend is indicated by F, a friend of a friend is indicated by FoF, a friend of the user's friend (a friend of F) is indicated by FoF, and a friend of the friend of the friend (a friend of FoF) is indicated by FoFoF.

Definition 2: A user's acquaintances, as used herein, are generally all people the user can know through an extended friend relationship. The user's friends are excluded from a list of acquaintances. That is, acquaintances generally refer to people the user can know by extending a chain of friend relationships involving the user's friend. The acquaintances are {FoF, FoFoF, FoFoFoF, . . .} and are, in brief, indicated by F(oF)+.

Here, ‘+’ is a repetition operator having an integer value. All friends and acquaintances having social relationships with the user are indicated by F(oF)*, where ‘*’ is a repetition operator having an integer value of 0, 1, 2, . . . . For example, a friend of the user's friend is indicated by FoF. In this case, the value of ‘+’ in F(oF)+ is 1. In addition, a friend of a friend of a friend of the use's friend (a friend of FoFoF) is indicated by FoFoFoF. In this case, the value of ‘+’ in F(oF)+ is 3.

Definition 3: A social connection path, as used herein, denotes a path that connects two users as acquaintances through friend relationships.

For example, a social connection path between user A and user C is A-B-C, and a social connection path between user A and user D is A-B-C-D.

Definition 4: A connector, as used herein, refers to a user's friend on a social connection path that connects the user and an acquaintance.

For example, in FIG. 1, a connector between user A and acquaintance D is user B.

Definition 5: A social distance, as used herein, is a value obtained by subtracting one from the number of users on a social connection path. A social distance of a shortest connection path from among social connection paths between users is referred to as a shortest social distance.

For example, in FIG. 1, a social distance between user A and user C is two.

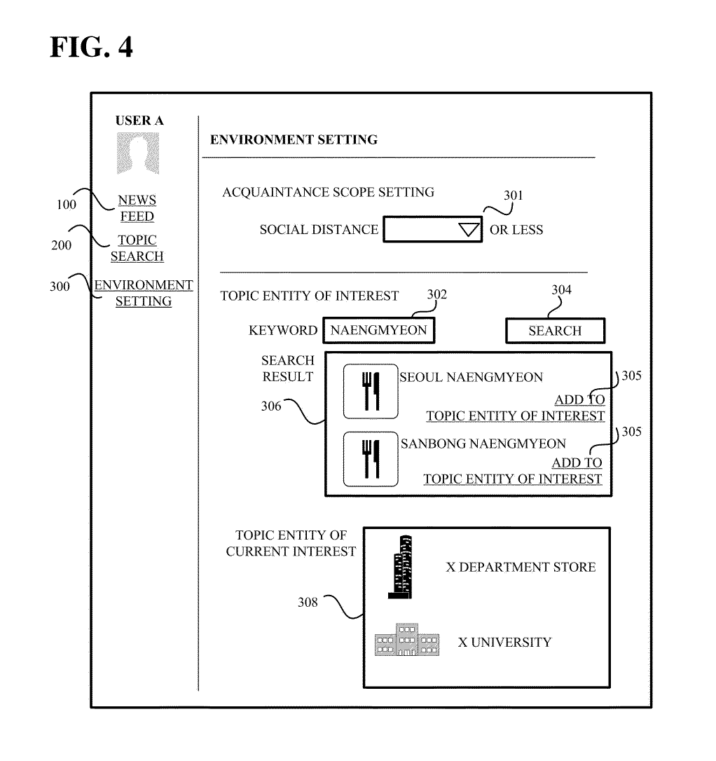

In the present invention, acquaintance relationships may be defined as relationships within a pre-defined social distance. This is because an individual at too far a social distance from a user is actually hard to be referred to as an acquaintance of the user. For example, relationships within a social distance of four from the user may be defined as the acquaintance relationships. The social distance used to define acquaintances of the user may be set by environment setting of the topic-based SNS according to the present invention. This will be described later with reference to FIG. 4.

Definition 6: In the present invention, topic entities, as well as SNS users, are SNS members. A topic entity is created for a specific topic and is registered in the SNS. Then, SNS users may check in a page of the topic entity and register comments on the specific topic. The topic entity can be created for any topic. For example, the topic entity can be a specific place or store based on location, a specific activity, a specific institution, or a specific work of art. To write comments in the page of the topic entity, it may be required to check in the topic entity.

Definition 7: Check-in is performed for a specific topic entity. The check-in process is performed at a check-in request from an SNS user. An SNS user who checks in a specific topic entity can write comments on the specific topic entity. If a topic entity that an SNS user wishes to check in is for a specific area or place, the SNS user may be allowed to check in the topic entity only when the location of the SNS user's terminal is in the specific area or place.

The topic-based SNS according to the present invention is provided based on the above relationships between users.

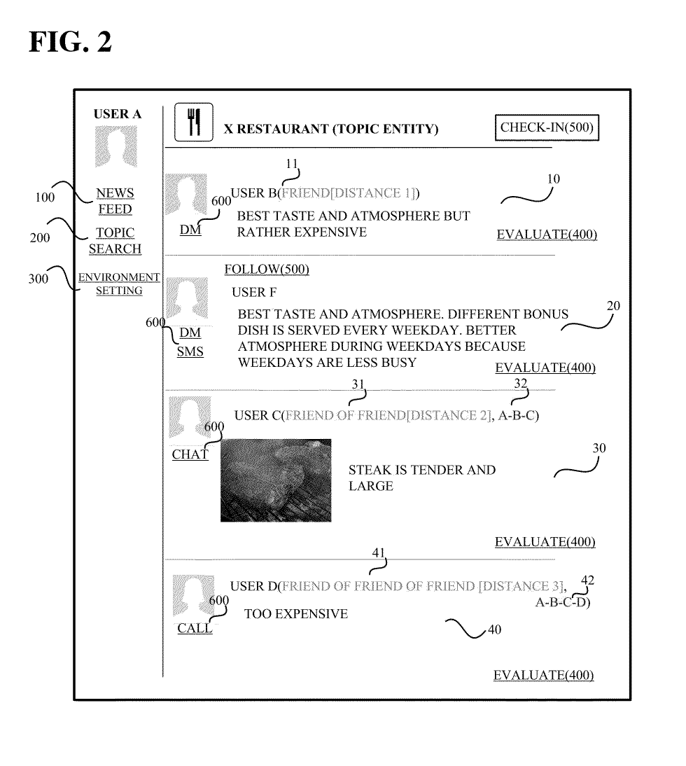

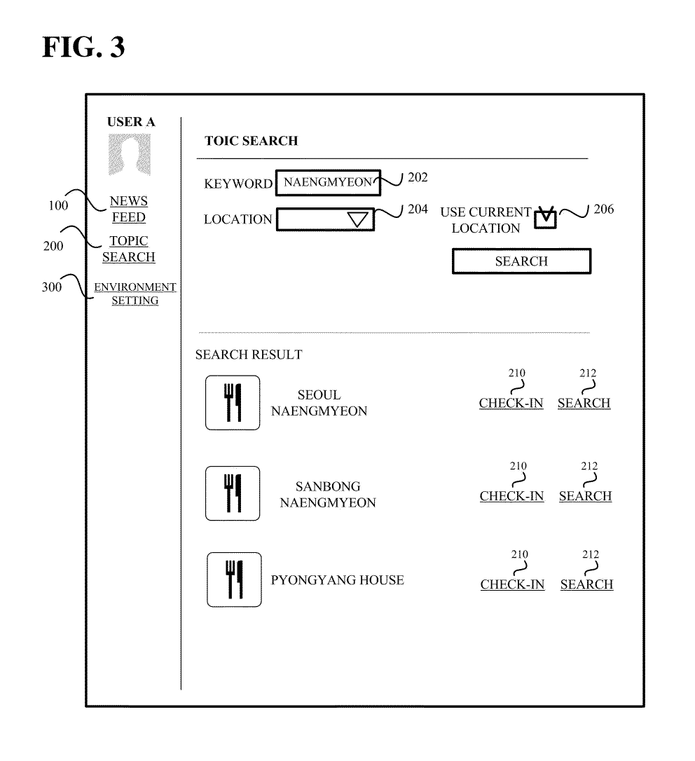

Hereinafter, a method of providing comment content about a specific topic entity according to an embodiment of the present invention will be described with reference to FIGS. 2 and 3.

FIG. 2 shows a topic entity user interface (UI) provided in a topic-based SNS according to an embodiment of the present invention. Referring to FIG. 2, user A is connected to the topic-based SNS, and the topic entity UI shows an “X restaurant topic entity.” On the left side are a newsfeed link 100, a topic search link 200, and an environment setting link 300 for displaying newsfeed, topic search and environment setting UIs provided by the topic-based SNS according to the current embodiment in a main area on the right side.

In a conventional SNS, a comment upload service for each topic entity allows any SNS user interested in a topic entity to post his or her opinion about the topic entity in the form of comment content. Therefore, an SNS user who opens the topic entity UI to obtain information about the topic entity can find various information. In this case, however, it is difficult to trust the content of comments written by each user.

In the method of providing the topic-based SNS according to the current embodiment, comment content written by users who have a friend or acquaintance relationship with a user connected to the topic-based SNS is selected from registered comment content about a topic entity, and the selected comment content only is provided as shown in FIG. 2. In this case, each comment content writer may try to write comment content as accurately as possible to the best of his or her knowledge since the writer is aware of the fact that the comment content will be provided to users who have a personal relationship with the writer. Therefore, users of the topic-based SNS according to the current embodiment can easily obtain reliable information about a specific topic entity.

In the method of providing the topic-based SNS according to the current embodiment, from among registered comment content about a specific topic entity, comment content written by users designated as experts on the specific topic entity may be provided in addition to comment content written by users who have a friend or acquaintance relationship with a user who logged in the topic-based SNS. Since the reliability of the comment content written by the users designated as the experts on the specific topic entity can be guaranteed even though the expert users have no personal relationship with the logged-in user, reliable information about the specific topic entity can be provided as much as possible in the method of providing the topic-based SNS according to the current embodiment.

Designating a user as an expert on a specific topic entity may be done by an SNS server based on at least one of the number of check-ins to the specific topic entity, the number of comments written on the specific topic entity, and an evaluation score for each comment on the specific topic entity. Even if the user is designated as the expert by the SNS server, the user can refuse to perform activities as the expert.

The user designated as the expert on the specific topic entity is obligated to evaluate comment content written about the specific topic entity by other users and disclose information about his or her location. At the same time, the expert user is entitled to predetermined points or gift certificates as rewards. That is, the user designated as the expert may be rewarded according to a reward policy of the topic-based SNS according to the current embodiment or according to a reward policy set for each topic entity. For example, a user designated as an expert on a topic entity for a specific restaurant may be entitled to a gift certificate that can be used in the restaurant or a discount in the restaurant. The reward policy for the expert may serve as an inducement for the expert to actively carry out activities, such as writing comment content about the topic entity.

The method of providing the topic-based SNS according to the current embodiment may include receiving from a user a follow request addressed to a friend of the user, an acquaintance of the user or an expert on a specific topic entity by using the SNS server and registering the user as a follower of the friend, the acquaintance or the expert by using the SNS server; and providing new comments on the specific topic entity to the follower user of the friend, the acquaintance or the expert by using the SNS server when the friend, the acquaintance or the expert uploads the new comments on the specific topic entity to the SNS server. The SNS server may provide the follower user of the friend, the acquaintance or the expert with the new comments in the form of a newsfeed, a direct message (DM) of the SNS, an email, or a short message service (SMS) message. The method used to provide the new comments may depend on the user's setting. Accordingly, an SNS user can be automatically provided with new comments made on a specific topic entity by a friend, an acquaintance or an expert who the user follows, even without visiting a UI of the specific topic entity.

In FIG. 2, four pieces of comment content 10 through 40 about the “X restaurant topic entity” are provided to user A. Users B, C and D have a friend or acquaintance relationship with user A. User F has no personal relationship with user A. However, since user F is a user designated as an expert on the “X restaurant topic entity,” comment content written by user F may be provided to user A.

Referring to FIG. 2, the comment content 10, 30 and 40 written by users B, C and D having a personal relationship with user A who logged in includes information about connection paths 11, 31, 32, 41 and 42 between user A and users B, C and D. Therefore, user A can intuitively identify his or her relationships with users B, C and D who wrote the comment content 10, 30 and 40. As a result, user A can trust the comment content 10, 30 and 40 more.

Also, referring to FIG. 2, at least one of a direct message, a chat request, an SMS message, an email, and a phone call to a comment content writer is provided as a contact medium in each piece of comment content in the form of link for contact 600. The type of the contact medium may be determined by the comment content writer. Thus, user A can contact each comment content writer and directly ask questions if he or she has any questions about each piece of comment content.

In addition, referring to FIG. 2, user A may give an evaluation score for each piece of comment content using an “evaluate” link 400 added to each piece of comment content. The evaluation score may be reflected in selecting an expert.

Furthermore, referring to FIG. 2, user A may click on a check-in button 500 to check in the “X restaurant topic entity.” When the “X restaurant topic entity” is location-based, whether to allow user A to check in the “X restaurant topic entity” may be determined based on location information of user A. After checking in the “X restaurant topic entity,” user A can write and register comment content.

FIG. 3 shows a topic search UI displayed when the topic search link 200 is clicked to search a topic.

Referring to FIG. 3, user A may enter a keyword in a search window 202 to find related topic entities. In addition, topic entities related to a specific location can be found by entering a location name 204. A check box 206 may also be used to find topic entities related to a current location. In FIG. 3, a case where ‘Naengmyeon’ (meaning “Korean traditional cold noodles”)-related topic entities near the current location are searched for is illustrated.

In FIG. 3, three topic entities are shown as search results related to the location of a terminal of user A and found using “Naengmyeon” as a keyword. User A may check in each topic entity (by clicking on a check-in link 210) or view each topic entity (by clicking on a view link 212) to find information about each topic entity. A click on the view link 212 shown in FIG. 3 may bring up the topic entity UI shown in FIG. 2.

FIG. 4 shows an environment setting UI in which settings related to the topic-based SNS according to the current embodiment are made. The environment setting UI of FIG. 4 may be displayed when the environment setting link 300 on the left side is clicked.

In the environment setting UI, a social distance which defines the scope of acquaintances may be set as indicated by reference numeral 301.

In addition, topic entities of interest may be set. When a friend, an acquaintance or an expert uploads new comment content to a topic entity selected as a topic entity of interest, the uploaded comment content may be provided to user A in the form of a newsfeed.

Referring to FIG. 4, two topic entities are displayed in a search result box 306 as a result of entering “Naengmyeon” in a search window 302 and clicking on a search button 304.

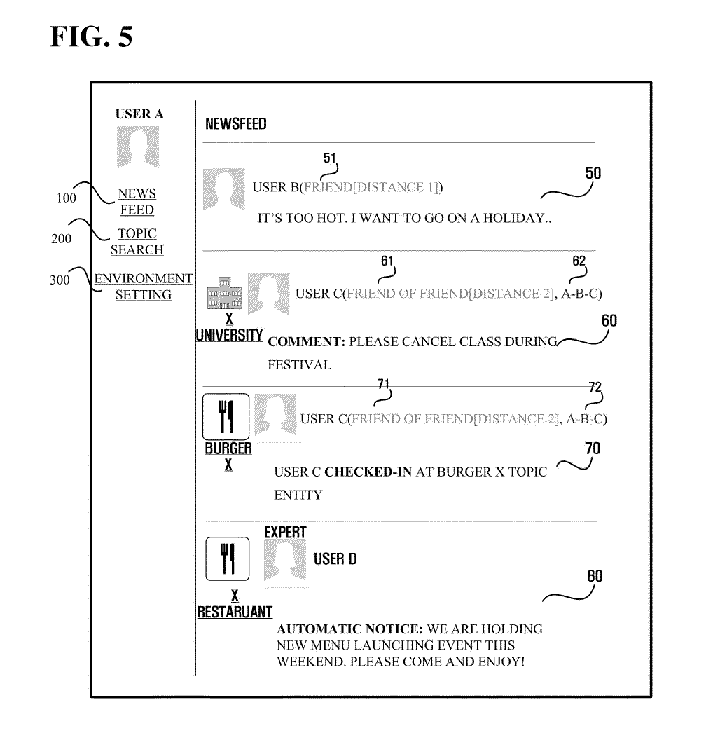

Also, topic entities that user A is currently interested in are displayed in a topic entity of current interest box 308. Of topic entities found as search results, desired topic entities can be added to a list of topic entities of interest by a click on an “add to topic entity of interest” link 305. FIG. 5 shows a newsfeed UI provided in the topic-based SNS according to the current embodiment.

A newsfeed service is a service for providing a link to uploaded content or the uploaded content itself in a page accessed by a user, so that the user can view the uploaded content without visiting a site to which the content was uploaded.

A newsfeed service of a conventional SNS provides a logged-in user with content, which is uploaded only by users having a friend relationship with the logged-in user, in the form of newsfeeds. However, a newsfeed service according to the current embodiment provides a logged-in user with content or comment content about a topic entity of interest, which is uploaded not only by users having a friend relationship with the logged-in user but also by users having an acquaintance relationship with the logged-in user, in the form of newsfeeds.

Referring to FIG. 5, four newsfeeds 50 through 80 are posted in a page accessed by user A. It is assumed that the “X restaurant topic entity” has been selected as a topic entity of interest of user A.

The first newsfeed 50 is a newsfeed of user B who is a friend of user A.

The second newsfeed 60 is comment content written about an “X university topic entity” by user C who is an acquaintance of user A, and the third newsfeed 70 is a newsfeed notifying that user C, an acquaintance of user A, has checked in “Burger X.”

The fourth newsfeed 80 is comment content of an expert on the topic entity of interest of user A.

As described above, the topic-based SNS according to the current embodiment provides information about a connection path between a user and a content writer to increase the reliability of content.

Referring to FIG. 5, social distance information 51, 61 or 71 and social connection path information 62 or 72 may be provided next to each user's name. The social distance information 51, 61 and 71 may be provided in the form of ‘friend,’ ‘friend of a friend,’ . . . or in the form of ‘distance 1’ (meaning a social distance of 1 from user A), ‘distance 2,’ . . . .

The newsfeed service of the topic-based SNS according to the current embodiment provides a logged-in user with comment content about each topic entity, which is uploaded to the SNS by users having a friend or acquaintance relationship with the logged-in user, in the form of newsfeeds. Therefore, reliable information about each topic entity created by friends or acquaintances of the logged-in user can be shared through newsfeeds.

Furthermore, when the logged-in user selects a topic entity of interest, the newsfeed service allows comment content about the topic entity of interest, which is uploaded by users having a friend or acquaintance relationship with the logged-in user or by experts on the topic entity of interest, to be shared in the form of newsfeeds. Thus, comment content about the topic entity of interest uploaded by experts, friends, and acquaintances can be shared through newsfeeds.

According to the present invention, a logged-in user is provided with comment content about a specific topic entity which is written only by users having personal relationships with the logged-in user or by experts on the specific topic entity. Therefore, the logged-in user can obtain reliable information about the specific topic entity.

In addition, since each comment content writer is aware that his or her comment content will be provided to users who have a personal relationship with the corresponding comment content writer, the reliability of the comment content can be guaranteed.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A method of providing a topic-based social network service (SNS), the method comprising:
receiving comment content about a topic entity in an SNS and storing the received comment content by using an SNS server which provides the SNS;
receiving a comment content request signal about a specific topic entity from a user who logged in the SNS, by using the SNS server; and
providing, in response to the comment content request signal, comment content written by users who have a friend relationship or an acquaintance relationship with the logged-in user in the SNS from among comment content written about the specific topic entity, by using the SNS server,
wherein one or more users of the SNS connect two SNS users who have the acquaintance relationship, through friend relationships in the SNS.

2. The method of claim 1, wherein the number of SNS users connecting the two SNS users, who have the acquaintance relationship, through the friend relationships is equal to or less than a predetermined number.

3. The method of claim 1, further comprising selecting an expert on the specific topic entity from SNS service users by using the SNS server, wherein the providing of the comment content comprises further providing comment content written by the expert from among the comment content written about the specific topic entity.

4. The method of claim 3, wherein the selecting of the expert comprises selecting the expert on the specific topic entity based on at least one of the number of check-ins to the specific topic entity, the number of comments written about the specific topic entity, and an evaluation score for each comment on the specific topic entity.

5. The method of claim 3, further comprising:
receiving from the logged-in user a follow request addressed to a friend of the logged-in user, an acquaintance of the logged-in user, or the expert by using the SNS server and registering the logged-in user as a follower of the friend, the acquaintance, or the expert by using the SNS server; and
providing new comments on the specific topic entity to the follower user of the friend, the acquaintance, or the expert by using the SNS server when the friend, the acquaintance, or the expert uploads the new comments on the specific topic entity to the SNS server.

6. The method of claim 3, further comprising offering a predetermined reward to the expert by using the SNS server.

7. The method of claim 1, wherein the receiving of the comment content and the storing of the received comment content comprises receiving comment content from an SNS user who checked in the topic entity and storing the received comment content by using the SNS server.

8. The method of claim 7, wherein the topic entity has location information as an attribute thereof, and the receiving of the comment content from the SNS user who checked in the topic entity and the storing of the received comment content comprises:
receiving a check-in request signal for the topic entity by using the SNS server, wherein the check-in request signal contains location information of a mobile terminal of the SNS user;
determining whether to allow the SNS user to check in the topic entity by comparing the location information of the mobile terminal and the location information of the topic entity using the SNS server; and
receiving the comment content by using the SNS server when the SNS user is allowed to check in the topic entity.

9. The method of claim 1, wherein the providing of the comment content comprises providing information about a social connection path between the logged-in user and a comment content writer in each piece of comment content.

10. The method of claim 1, wherein the providing of the comment content comprises providing at least one of a direct message, a chat request, a short message service (SMS) message, an e-mail, and a phone call to a comment content writer as a contact medium in each piece of comment content.

11. A method of providing a topic-based SNS, the method comprising:
receiving comment content about a topic entity in an SNS and storing the received comment content by using an SNS server which provides the SNS; and
providing a user who logged in the SNS with comment content about each topic entity, which is uploaded to the SNS by users having a friend relationship or an acquaintance relationship with the logged-in user in the SNS, in the form of newsfeeds by using the SNS server,
wherein one or more users of the SNS connect two SNS users, who have an acquaintance relationship, through friend relationships.

12. The method of claim 11, further comprising selecting a topic entity of interest of the logged-in user by using the SNS server, wherein the providing the logged-in user with the comment content about each topic entity in the form of the newsfeeds comprises providing the user who logged in the SNS with comment content about the topic entity of interest, which is uploaded to the SNS by users having a friend relationship or an acquaintance relationship with the logged-in user or by experts on the topic entity of interest, in the form of newsfeeds.
